(19) United States
(12) Patent Application Publication
(10) Pub. No.: US 2014/0308638 A1
(43) Pub. Date: Oct. 16, 2014

(54) USING AN EARNED POINTS SYSTEM TO PROVIDE INTERNET ACCESS

(71) Applicant: Intrinsic Value Software, Inc., Bozeman, MT (US)

(72) Inventors: Ryan Stout, Bozeman, MT (US); Corey Stout, Pittsburgh, PA (US); Rob Irizarry, Bozeman, MT (US)

(73) Assignee: Intrinsic Value Software, Inc., Bozeman, MT (US)

(21) Appl. No.: 14/254,526

(22) Filed: Apr. 16, 2014

Related U.S. Application Data
(60) Provisional application No. 61/812,592, filed on Apr. 16, 2013.

(51) Int. Cl. G09B 7/02

(52) U.S. Cl. CPC G09B 7/02
USPC 434/236

(57) ABSTRACT

Systems and methods to restrict or meter internet access and usage using virtual currency based on chores, behaviors, and activities. The systems and methods allow controlled internet access using positive rewards, negative rewards, positive punishment, and negative punishment. Described herein is a system and method to create chores, behaviors, and activities that either grant or remove access or allow the earning of points with the conversion of the points into recreational internet access time, money, merchandise, or other reward.

### CROSS-REFERENCE TO RELATED APPLICATIONS

This Application claims priority to U.S. Provisional Patent Application No. 61/812,592 filed Apr. 16, 2013 to Ryan Stout et al. entitled “Using an Earned Points System to Provide Internet Access,” currently pending, the entire disclosure of which is incorporated herein by reference.

### FIELD

This disclosure relates generally to systems and methods for regulating internet access via earned points, more particularly, to providing an automatic process for tracking behaviors and applying a score to each behavior to limit, regulate, or allow access to the internet.

### BACKGROUND

Families commonly require members to perform chores or other activities and behaviors. However, while multiple methods exist for tracking these chores, activities, and behaviors exist, all have flaws of various natures. Manual tally sheets and tracking boards, for instance, are often forgotten during the verification and update stage of tracking and are commonly unable to adequately reflect the difference between required and optional items. Similarly, the manual methods don't allow the representation of varying reward for each task by ability level. Other approaches, such as behavior modification techniques, color code levels to individual behaviors and the individual can move between levels. These types of approaches inadequately track as well as reward or punish individuals and often include a subjective component.

Automated approaches alleviate some of these problems but still prove inadequate in modern households. Commonly these methods are simply electronic versions of the manual paper methods in more common use. While these electronic methods may provide a minor amount of additional structure and formality to the process, they still lack a robust set of tracking and reward capabilities.

In addition, all existing methods commonly lack a number of valuable components to tracking and rewarding or punishing behaviors for the best outcome in a modern family. First, with traditional and current electronic methods, the parent or supervisor must monitor and verify outcomes and subsequently then mete out the rewards or punishments as well as monitor the proper adherence and use of the resulting outcome. In this role the parent or supervisor is viewed as an enforcer rather than a supportive coach to increase the positive outcomes.

Next, parents and supervisors are unable to adequately monitor the implementation of rewards and punishments applied as a result of the chore, activity, or behavior outcome. For instance, the simplest method commonly employed for a reward is money. Once the money is provided to the individual, that money may be spent in any number of unmonitored ways. Similarly, if the punishment is the removal of, say, TV permissions, then the parent must monitor the amount of time the TV is in use during the punishment period; commonly the parent is not always present to monitor this restriction.

Next, parents and supervisors are not commonly knowledgeable of the variety of psychological techniques well known in the art to use in each of a variety of occurrences to affect the best outcomes. For instance, most commonly parents may provide a simple monetary reward for each task. More savvy parents may also reduce the award if undesired behaviors occur within the same period. Unfortunately, that range of simple reward and punishment behaviors is lacking in the full breadth understood by psychologists. For instance, behavioral psychology has long known about the four distinct methods for modifying behavior: positive reinforcement, negative reinforcement, positive punishment, and negative punishment. In this terminology, reinforcement refers to encouraging the increase of a behavior and punishment refers to encouraging the decrease of a behavior. Positive refers to providing something and negative refers to taking something away. Using this terminology, most parents are familiar only with positive reinforcement (e.g. providing money for chores well done) or negative punishment (e.g. removing earned money for bad behaviors). Missing are the removal of restrictions for good behaviors or the application of restrictions for bad behaviors. And, if these techniques are used they are used inconsistently.

Next, parents and supervisors are often unaware of common chores, activities, and behaviors for each age group of child, and similarly are unaware of common reward (or punishment) rates for each given chore, activity, and behavior set. In the absence of this knowledge, each child's task list as well as reward and punishment is somewhat arbitrary and opens the family for needless conflict

Finally, in the modern family there is recognition of a variety of rewards and punishments that are possible but not well codified. For instance, successful completion of a set of chores could result in monetary payment of a certain amount, a certain amount of entertainment access (e.g. internet access, television viewing time, computer gaming), a certain amount of merchandise (e.g. via iTunes or Amazon or access to a present from a toy chest), or even a certain amount of other interactions (e.g. spending special time with a parent, attending a friend's party). No existing system recognizes the variety of reward redemption choices (or punishment options) for a set of chores, activities, or behaviors.

### BRIEF DESCRIPTION OF THE DRAWINGS

FIG. 1 is a block diagram of an example embodiment of a figure upon which embodiment's inventive subject matter can execute;

FIG. 2 is a block diagram of an example embodiment of the interaction between electronic hardware, software, and the internet as pertains to the inventive subject matter;

FIG. 3 is a flowchart of one particular method for configuring components in accordance with using virtual currency for internet access according to embodiments;

FIG. 4 is a flowchart of one particular method for configuring user accounts in accordance with using virtual currency for internet access according to embodiments;

FIG. 5 is a flowchart of one particular method for configuring chores, tasks, and behaviors in accordance with using virtual currency for internet access according to embodiments;

FIG. 6 is a flowchart of one particular method for configuring rewards in accordance with using virtual currency for internet access according to embodiments;

FIG. 7 is a flowchart of one particular method for configuring activities in accordance with using virtual currency for internet access according to embodiments;

FIG. 8 is a flowchart of one particular method for configuring approved sites in accordance with using virtual currency for internet access according to embodiments;

FIG. 9 is a flowchart of one particular method for allowing internet access in accordance with using virtual currency according to embodiments;

FIG. 10 is a flowchart of one particular method for configuring bundles of tasks, rewards, activities, sites, etc. in accordance with using virtual currency for internet access according to embodiments;

FIG. 11 is a flowchart of one particular method for redeeming virtual currency for internet access according to embodiments.

### DETAILED DESCRIPTION

In the following detailed description of example embodiments, reference is made to the accompanying drawings that form a part hereof, and in which is shown by way of illustration specific example embodiments in which the inventive subject matter may be practiced. These embodiments are described in sufficient detail to enable those skilled in the art to practice the inventive subject matter, and it is to be understood that other embodiments may be utilized and that logical, mechanical, electrical and other changes may be made without departing from the scope of the inventive subject matter.

Some portions of the detailed descriptions which follow are presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

In the Figures, the same reference number is used throughout to refer to an identical component that appears in multiple Figures. Signals and connections may be referred to by the same reference number or label, and the actual meaning will be clear from its use in the context of the description. Also, please note that the first digit(s) of the reference number for a given item or part of the example embodiments should correspond to the Figure number in which the item or part is first identified.

The description of the various embodiments is to be construed as exemplary only and does not describe every possible instance of the inventive subject matter. Numerous alternatives can be implemented, using combinations of current or future technologies, which would still fall within the scope of the claims. The following detailed description is, therefore, not to be taken in a limiting sense, and the scope of the inventive subject matter is defined only by the appended claims.

For illustrative purposes, various embodiments may be discussed below with reference to virtual currency for internet access. The most common example discussed in detail is providing an internet access point which allocates internet usage based upon a set of rewards and punishments based on 3^{rd} party recorded behaviors. This is only one example of a suitable environment and is not intended to suggest any limitation as to the scope of use or functionality of the inventive subject matter. Neither should it be interpreted as having any dependency or requirement relating to any one or a combination of components illustrated in the example operating environments described herein.

In general, various embodiments combine, in virtual currency for internet access, the opportunity to construct a set of internet access permissions based upon a set of chores, activities, and behaviors. Thus some embodiments provide tokens (positive reinforcement) for each completed household chore, each physical activity (e.g. walking or other exercise), and each behavior (e.g. completed homework). Similarly, some embodiments remove tokens (negative punishment) for untimely or missed household chores, lack of physical activity, or each bad behavior (e.g. fighting). Further, some embodiments remove restrictions (negative reinforcement) (e.g. removal of internet site restrictions or relaxing age/content filters) for positive outcomes, while some embodiments may apply restrictions (positive punishment) (e.g. increased internet filters, tighter age/content filters) for negative outcomes.

In the specifics of discussing virtual currency for internet access, several definitions will be used in the specification. First, “virtual currency” is any process relating to an abstract reward token. Specifically, the reward token must include or have the capacity to be redeemed as a variety of items, including in some embodiments money, time (whether internet or on other desired activities) and may also include in some embodiments the manifestation of content filters. In this specification the term “virtual currency” is interchangeable with “token” “chit” “kudo” “points” or any other similar common term. Next, “reward” is any process relating to reinforcing a behavior. Specifically, a “reward” is the same as “reinforcement”, the act of increasing the likelihood of a behavior. Similarly, “punishment” is any process relating to decreasing a behavior. In the context of virtual currency, most commonly a “reward” is the granting of a certain amount of virtual currency (e.g. positive reinforcement), but is not limited to simply providing virtual currency. A “reward” could also include removing restrictions (e.g. negative reinforcement). Each type of “reward” is interchangeable within the current specification, but the specific meaning may be further clarified in some contexts and embodiments. Also within the context of virtual currency, most commonly a “punishment” is the removal of a certain amount of virtual currency (e.g. negative punishment), but is not limited to simply removing virtual currency. A “punishment” could also include increasing restrictions (e.g. positive punishment). Each type of “punishment” is interchangeable within the current specification, but the specific meaning may be further clarified in some contexts and embodiments. In addition, a “chore” or “task” or “activity” or “behavior” could be used interchangeably to refer to something that is tracked or measured for either reward or punishment.

In the present disclosure, certain embodiments are related to chores and other tasks and behaviors. Each of these is initially configured for each individual in the system and tracking is recorded by an administrator (e.g. a parent) to mark completion, existence, progress, or the like. Each chore, behavior, or activity could be related to specific units of time, such as morning or evening, daily, weekly, monthly, et. cetera. Similarly, specific times may not apply to all chores, behaviors, or activities depending upon the embodiment. In addition, certain embodiments recognize distinct access points for access to the internet for tracking behaviors, including desktop computers, laptop computers, tablet computing devices, phones, motion sensing devices (e.g. pedometers), televisions, computer game consoles, entertainment devices (e.g. Roku® devices, digital video recorders (DVRs), DVD or BlueRay™ devices, etc.), or other devices which connect to the internet either directly or indirectly.

In certain embodiments each individual or group of chores could be part of a base requirement, wherein all must be completed before any reward is provided, while others may be part of a bonus requirement, wherein each individual completion imparts independent reward. Similarly, punishments may be allocated based upon single or groups of behaviors in some embodiments. Thus, depending upon the embodiment, a child may only receive a reward after all base requirement chores are completed, or may receive a reward for bonus chores are completed even if the base requirement chores are incomplete, or may receive a reward upon the completion of each base requirement chore. Further, in some embodiments the various tasks may include a varying reward (or punishment) level associated. And in some embodiments, the individual tasks may have different rewards (or punishments) based upon the individual doing the action.

In some embodiments the virtual currency can be redeemed as time or as money. The conversion of the virtual currency to time and money can come with varying conversion factors. For example, if the virtual currency is tracked as “kudos”, one kudo could be redeemed for $1, 1 hour of educational entertainment (e.g. National Geographic television, chess games, Wii-fit games), or 30 minutes of uneducational entertainment (e.g. cartoons, jump and shoot video games, etc.). Various conversion factors are allowed depending upon the embodiment. Similarly, in some embodiments the redemption of kudos could be handled directly via internet banking or via connection with various merchandisers (e.g. iTunes, Amazon, etc.). In some embodiments the current account balance could be viewed, either as the virtual currency or the potential conversion amounts of the virtual currency.

In some embodiments badges and other gamification approaches can be applied to the various chores or virtual currency. For example, a badge may be earned for completing a chore on time for each of seven consecutive days, or for reaching a certain amount of saved points. In some embodiments each achieved goal or badge could unlock additional bonus awards.

In yet other embodiments, internet access is recognized as having different natures depending upon the internet site. For example, the educational site of Khan Academy or the reference site of Wikipedia could be recognized as distinct from an internet gaming site. In certain embodiments the educational and reference (or other specific categories of “approved”) sites could be accessed regardless of the virtual currency status, while other sites would require the redemption of the virtual currency to access. Similarly, in some embodiments, access to certain sites (e.g. education sites like Khan Academy) may be one of the activities which allow an individual to earn virtual currency.

In yet another embodiment, groups of chores can be constructed and used. For example, a package or bundle of tasks could be made as an educational package for 3^{rd} grade math across one or more internet sites, such as the Khan Academy and others. This bundle could then be used as an activity the child could use to earn virtual currency. The disclosed system could include a number of pre-configured bundles parents could use as defaults, including chore lists, behavioral activities, educational activities, physical exercise activities, etc. In some embodiments the bundles could be tailored to specific age groups, such as a 5-year old child chore list or a 15-year old child chore list. In addition, in some embodiments, the bundles could be selectable from a set of defaults, they could be created by parents during a configuration exercise, or they could be downloaded or accessed from 3^{rd} party location, either for free or for payment. Similarly, some embodiments support the use of bundles for specifying internet access permissions. For example, a 5-year old access bundle that includes access to movies rated only G, and specific child-safe internet sites, whereas a 15-year old access bundle could include access to PG-13 movies, Facebook, and some teen-safe internet sites. Some embodiments include a specification of a standardized bundle definition language (BDFL) to support 3^{rd} party generation of bundles. Some embodiments could include the addition or removal of bundles as part of a reward or punishment based upon behaviors.

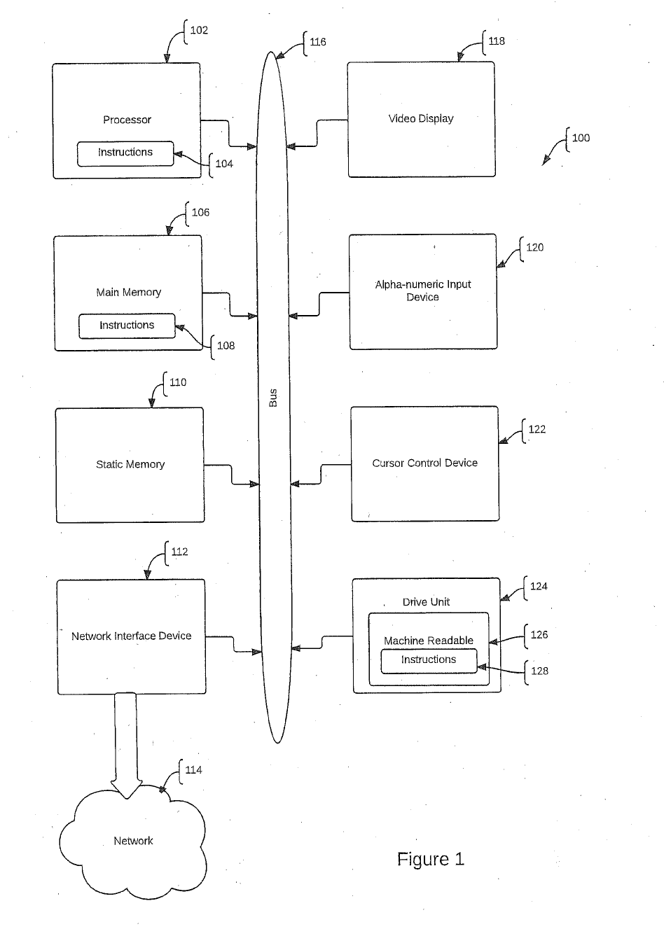

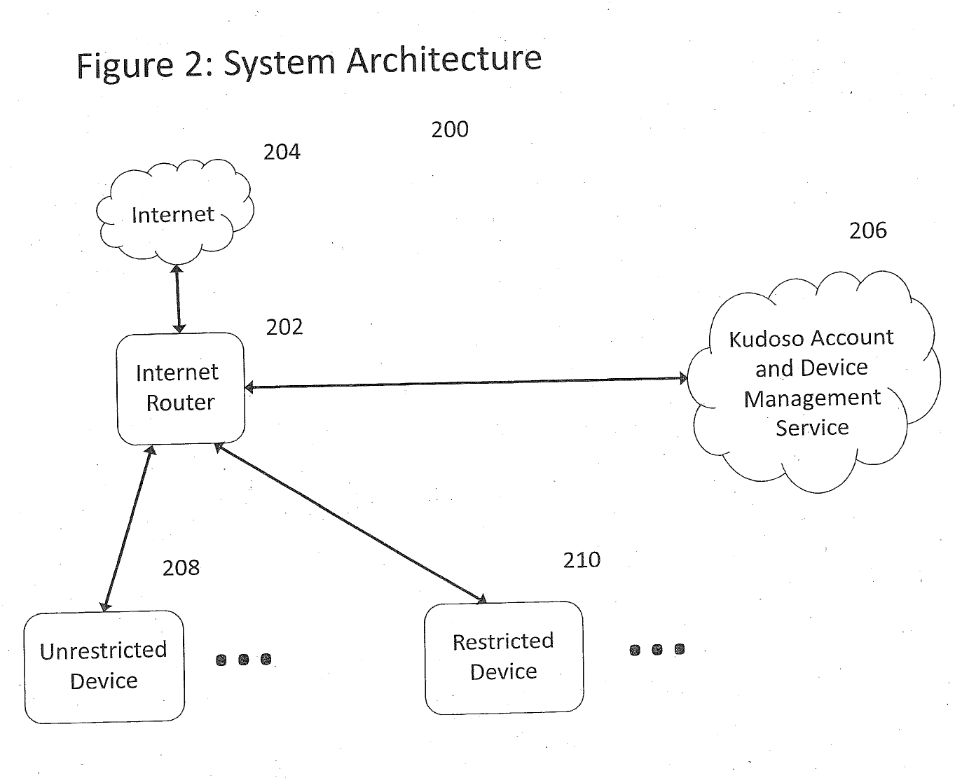

The following examples are provided to illustrate the operation of the above described systems and methods. Where applicable, references are made to figures as described. Figure element indicators are used to indicate specific figure elements where numerics 1xx refer to elements from FIG. 1, 2xx refer to elements from FIG. 2, and so on. Where the various examples are presented as an interconnected narrative, the interconnection is not necessary or expected as an aspect of the inventive subject matter. The embodiments may only provide functionality for any single example, or even a related topic obvious to one of ordinary skill in the art, and still provide an experience unique in the art. In the examples below, references to “virtual currency” refer to a system incorporating embodiments of the inventive subject matter.

FIG. 1 is a block diagram of an example embodiment of a computer system 100 upon which embodiment's inventive subject matter can execute. The description of FIG. 1 is intended to provide a brief, general description of suitable computer hardware and a suitable computing environment in conjunction with which the embodiments may be implemented. In some embodiments, the embodiments are described in the general context of computer-executable instructions, such as program modules, being executed by a computer. Generally, program modules include routines, programs, objects, components, data structures, etc., that perform particular tasks or implement particular abstract data types.

The system as disclosed herein can be spread across many physical hosts. Therefore, many systems and sub-systems of FIG. 1 can be involved in implementing the inventive subject matter disclosed herein.

Moreover, those skilled in the art will appreciate that the embodiments may be practiced with other computer system configurations, including hand-held devices, multiprocessor systems, microprocessor-based or programmable consumer electronics, network PCs, minicomputers, mainframe computers, and the like. The embodiments may also be practiced in distributed computer environments where tasks are performed by I/O remote processing devices that are linked through a communications network. In a distributed computing environment, program modules may be located in both local and remote memory storage devices.

In the embodiment shown in FIG. 1, a hardware and operating environment is provided that is applicable to both servers and/or remote clients.

With reference to FIG. 1, an example embodiment extends to a machine in the example form of a computer system 100 within which instructions for causing the machine to perform any one or more of the methodologies discussed herein may be executed. In alternative example embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. Further, while only a single machine is illustrated, the term “machine” shall also be taken to include any collection of machines that individually or jointly execute a set (or multiple sets) of instructions to perform any one or more of the methodologies discussed herein.

The example computer system 100 may include a processor 102 (e.g., a central processing unit (CPU), a graphics processing unit (GPU) or both), a main memory 106 and a static memory 110, which communicate with each other via a bus 116. The computer system 100 may further include a video display unit 118 (e.g., a liquid crystal display (LCD) or a cathode ray tube (CRT)). In example embodiments, the computer system 100 also includes one or more of an alpha-numeric input device 120 (e.g., a keyboard), a user interface (UI) navigation device or cursor control device 122 (e.g., a mouse, a touch screen), a disk drive unit 124, a signal generation device (e.g., a speaker), and a network interface device 112.

The disk drive unit 124 includes a machine-readable medium 126 on which is stored one or more sets of instructions 128 and data structures (e.g., software instructions) embodying or used by any one or more of the methodologies or functions described herein. The instructions 128 may also reside, completely or at least partially, within the main memory 108 or within the processor 104 during execution thereof by the computer system 100, the main memory 106 and the processor 102 also constituting machine-readable media.

While the machine-readable medium 126 is shown in an example embodiment to be a single medium, the term “machine-readable medium” may include a single medium or multiple media (e.g., a centralized or distributed database, or associated caches and servers) that store the one or more instructions. The term “machine-readable storage medium” shall also be taken to include any tangible medium that is capable of storing, encoding, or carrying instructions for execution by the machine and that cause the machine to perform any one or more of the methodologies of embodiments, or that is capable of storing, encoding, or carrying data structures used by or associated with such instructions. The term “machine-readable storage medium” shall accordingly be taken to include, but not be limited to, solid-state memories and optical and magnetic media that can store information in a non-transitory manner, i.e., media that is able to store information for a period of time, however brief. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

The instructions 128 may further be transmitted or received over a communications network 114 using a transmission medium via the network interface device 112 and utilizing any one of a number of well-known transfer protocols (e.g., FTP, HTTP). Examples of communication networks include a local area network (LAN), a wide area network (WAN), the Internet, mobile telephone networks, Plain Old Telephone (POTS) networks, wireless data networks (e.g., WiFi and WiMax networks), as well as any proprietary electronic communications systems that might be used. The term “transmission medium” shall be taken to include any intangible medium that is capable of storing, encoding, or carrying instructions for execution by the machine, and includes digital or analog communications signals or other intangible medium to facilitate communication of such software.

The example computer system 100, in the preferred embodiment, includes operation of the entire system on a remote server with interactions occurring from individual connections over the network 114 to handle user input as an internet application.

FIG. 2 is a block diagram of an example embodiment of a computer networking environment 200 upon which embodiment's inventive subject matter can execute. The description of FIG. 2 is intended to provide a brief, general description of a suitable computing environment in conjunction with which the embodiments may be implemented. The system as disclosed herein can be spread across many physical hosts. Therefore, many systems and sub-systems of FIG. 2 can be involved in implementing the inventive subject matter disclosed herein.

With reference to FIG. 2, an example embodiment extends to a machine in the example foam of an internet router 202 provides for network communications with one or more local devices 208, 210 and interfacing with the internet. Internet routers 202 can be wired or wireless, both for their connections with local devices as well as with the internet 204 or other computer networks. Commonly these devices are also known as “gateways” or “hubs” or “access points”, among many other common monikers when discussing internet hardware access points. Internet routers 202 contain software to control their configuration and execution. Said software may be deeply embedded within the electronic hardware and unchangeable, or it may be modifiable via numerous methods. The software controls, among many other things, which local devices may connect and which are disallowed, which may have restrictions 210 or which are unrestricted 208. Similarly, the internet router 202 software also determines which internet 204 sites are accessible and under what conditions access is allowed. The internet router 202 software also commonly contains logging, reporting, and other management functions.

Continuing with the description of FIG. 2, the unrestricted devices 208 are one or more devices which may access the internet 204 or other network or even other devices on the same local network. Unrestricted devices 208 may access other devices or the internet without any restrictions on access control, including network locations accessed or time windows or time limitations. By contrast, restricted devices 210 are not granted full access permissions and may have limitations based upon specific time of day, amount of usage, accessible sites, or other similar limitations.

FIG. 2 also includes the Kudoso Account and Device Management Service (KADMS) 206, disclosed in more detail in subsequent Figures and descriptions, which interacts with the internet router 202 to handle many of the configurable components relating to users, devices, and access management. The KADMS is part of the software controlling the internet router 202 as previously described. Said software may exist in the internet router 202 hardware, or even on alternate servers either on the local network or on the internet 204. If the KADMS exists external to the internet router 202, it may exist across multiple computer systems in, e.g. a cloud computing environment. If the KADMS exists external to the internet router 202, communication pathways must exist to allow certain user, device, and access management information to be relayed between the disparate systems.

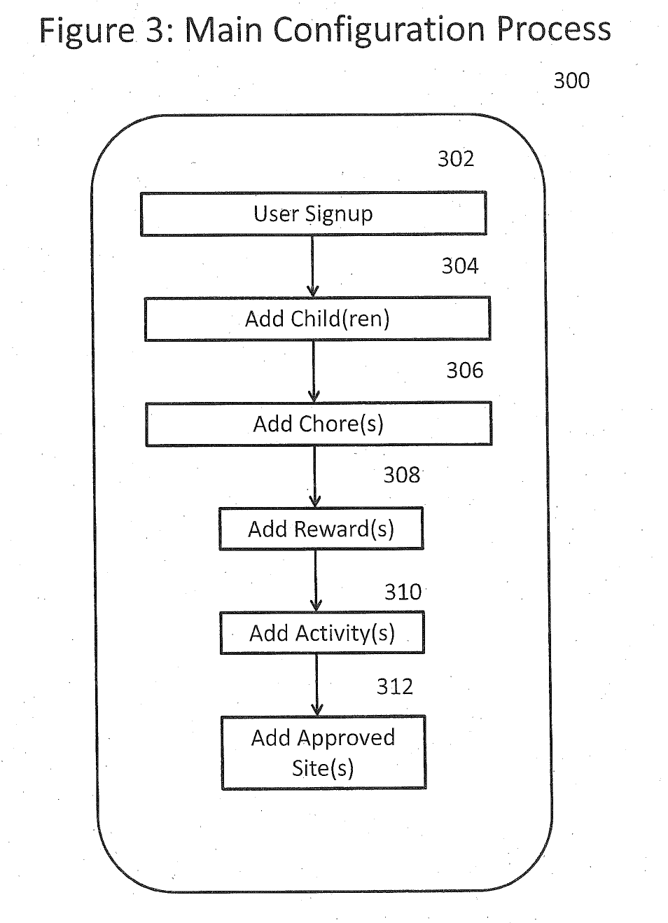

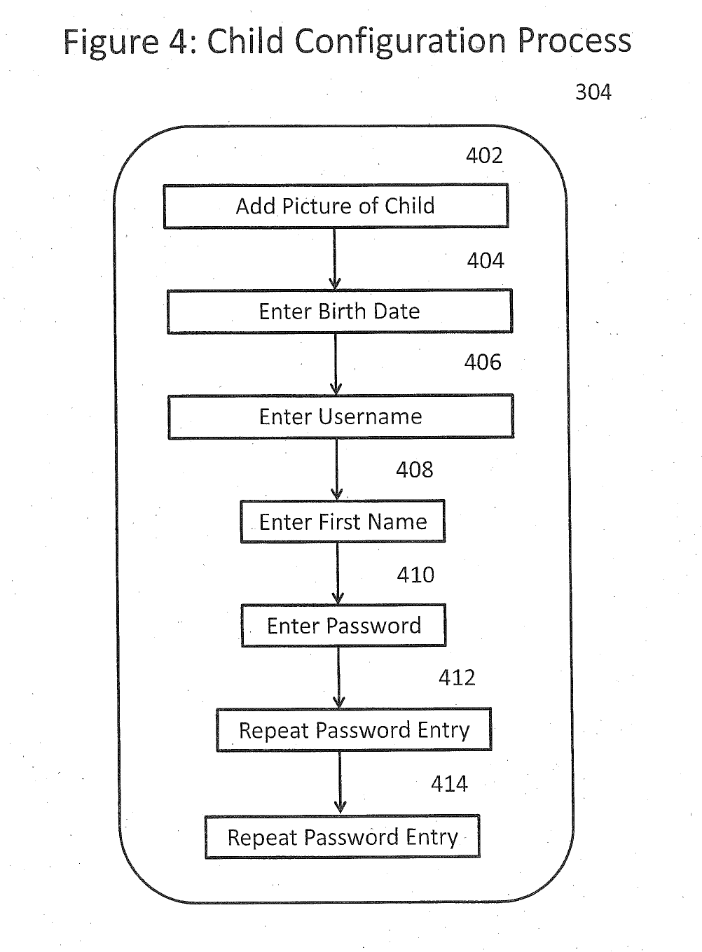

FIG. 3 is a flow chart of the main configuration process 300 of an example embodiment. Individual steps in the flow chart are described in more detail in FIGS. 4-8. Configuration initiates with user signup 302 to record the identifying information for configuration, including, for example, the administrator information. While the following steps are listed in a specific order, they could appear in alternate orders in alternate embodiments without changing the scope or function of the disclosure. Similarly, the steps could be interspersed or performed in different orders within the same embodiment depending on user choice, and are explained in a particular order only for clarity and simplicity of explanation but without any intended limitation. The signed up user 302 now adds one or more children or non-administrative users 304. After adding the children, a list of chores is added 306. In this context, chores could be work tasks. In certain embodiments the chores are independent entities assigned to individuals, while in other embodiments the chores are specific to each individual. Next, rewards are added 308. In some embodiments the rewards are independent entities associated with chores and individuals, but in other embodiments the reward is associated with a specific chore, a specific child, a combination of chore and child, or is specific to any of the chore, child, or combination thereof. Next, the administrative user 302 adds activities 310. Activities in this context could describe behaviors either desired or undesired, or physical activities such as exercise. Finally, a list of approved (and in some embodiments dis-approved) sites accessible 312. The approved (and dis-approved) sites in certain embodiments could apply in all circumstances, or in other embodiments could apply to sites accessible (or not accessible) in other situations, such as upon redemption of a reward.

FIG. 4 is a flow chart describing the process of adding a child 304 initially described in FIG. 3. In certain embodiments the steps in FIG. 4 could be performed in an alternate order, and in some embodiments not all steps are required. The list of steps included in FIG. 4 is representative of a variety of common situations without being limiting to a specific combination or order. In certain embodiments the first step of configuring a child is adding a picture of the child 402 to the child (or user) profile. Next, the birth date is added 404 to the profile. While the picture 402 is useful primarily as an easy visual indicator, the birth date 404 is potentially useful for identifying, e.g. age restrictions or age-related functionalities. Next a username is entered 406 for the child as an identifier used for tracking the individual and associating hardware devices. Each username 406 has an associated user first name entered 408 and password 410. To prevent errors, in some embodiments a second prompting for the same password is requested 412 one or more 414 times. This information or similar information in alternate embodiments may be part of the child (or user) configuration process. Similarly, the configuration approach is equally viable if the first step is entering a name 408 or a username 406, with other steps occurring in other orders as well.

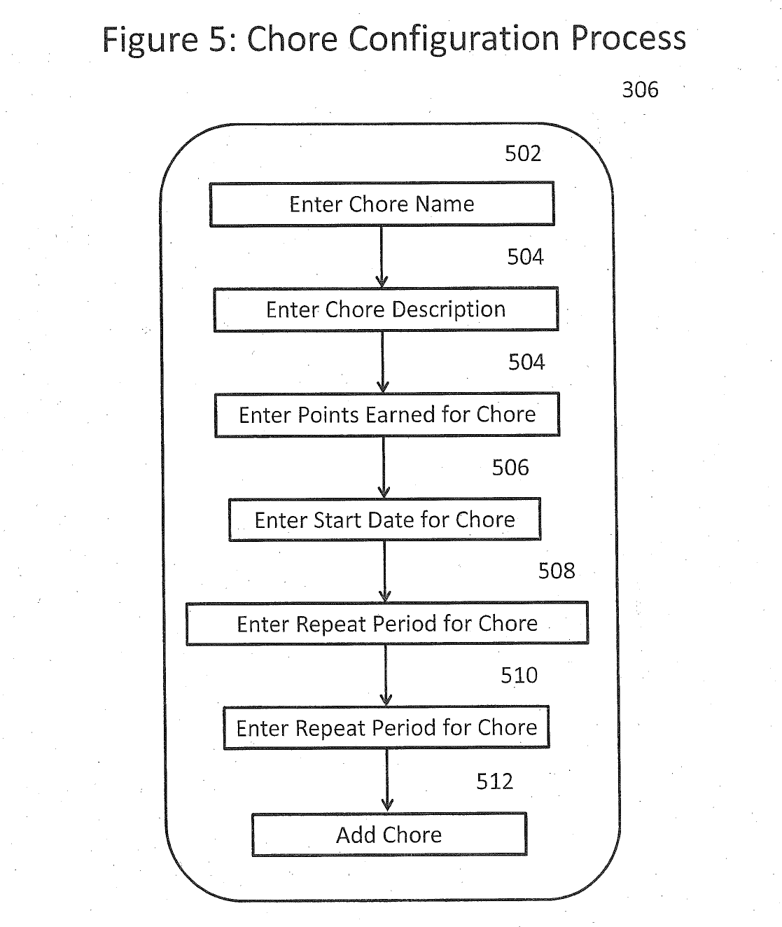

FIG. 5 is a flow chart describing the process of adding a chore 306 initially described in FIG. 3. In certain embodiments the steps in FIG. 5 could be performed in an alternate order, and in some embodiments not all steps are required. The list of steps included in FIG. 5 is representative of a variety of common situations without being limiting to a specific combination or order. In certain embodiments the first step of configuring a chore is entering a chore name 502 which is used to identify the chore. The next step is to create a description for the chore 504 which is used for informational purposes. In some embodiments the next step is to enter the number of points earned for performing the chore 506. Next the dates 508 and frequencies 510, 512 are entered for the chore as appropriate for various embodiments. The dates and frequencies allow for various combinations of when chores must be performed, e.g. every Monday, Wednesday, and Friday or on the first of every month, or on June 22, or any other variation of dates and repetition frequencies. Finally, when all information is correct, the chore is added to the system 514.

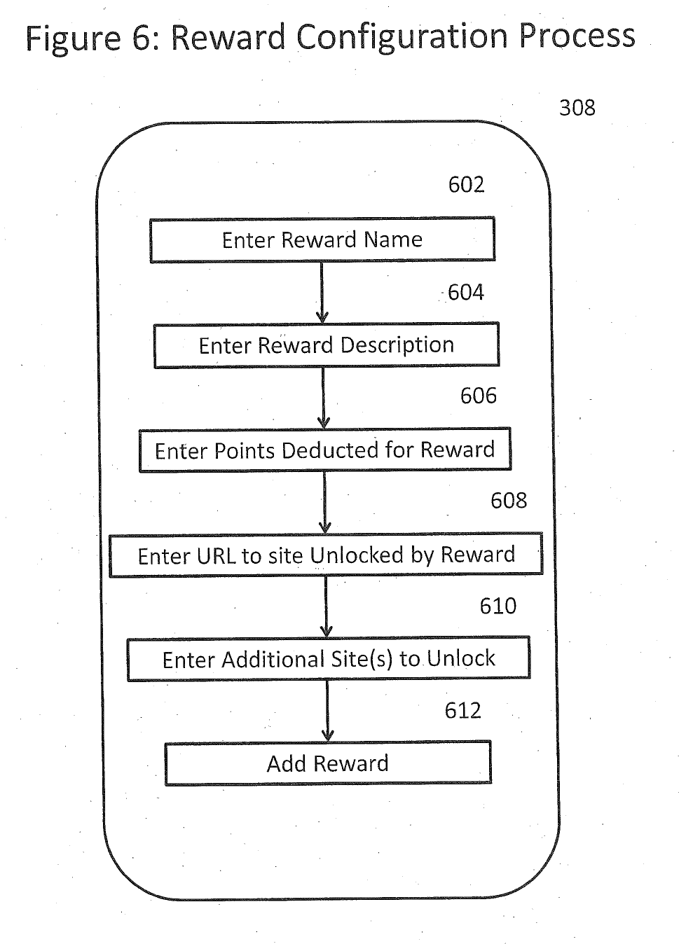

FIG. 6 is a flowchart describing the process of configuring a reward 308 originally described in FIG. 3. In certain embodiments the various steps in FIG. 6 could be performed in an alternate order and in some embodiments not all steps are required. As with prior figures, the list of steps is presented for descriptive purposes and the steps may be presented in any number of different combinations depending upon the embodiment. In certain embodiments the first step for creating a reward is to enter the reward name 602 which is used as an identifier for the reward. Next is the entry of the reward description 604 used for informational purposes. What follows is the entry of the number of points deducted for the reward 606 when the reward is redeemed by an individual. In some embodiments there follows the entry of a URL to a site that is unlocked by redeeming the award 608 and possibly additional sites unlocked by the reward 610. In some embodiments there may also be access time restrictions on the URL 608 and sites 610, such as only between 5pm and 9pm, or other various restrictions. Finally, once the reward configuration is complete, the reward is added 612 to the system.

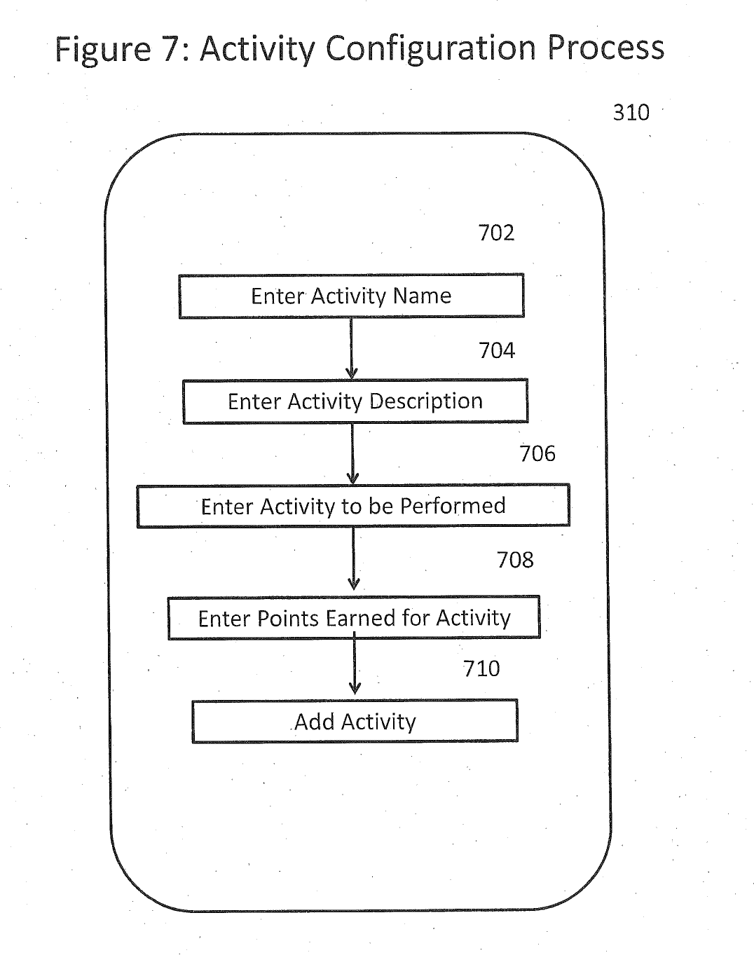

FIG. 7 is a flow chart of the activity configuration process 310 originally described in FIG. 3. In certain embodiments the various steps in FIG. 7 could be performed in an alternate order and in some embodiments not all steps are required. As with prior figures, the list of steps is presented for descriptive purposes and the steps may be presented in any number of different combinations depending upon the embodiment. In certain embodiments the first step for creating an activity is generating the activity name 702 which is used as an identifier for the activity. Next is the entry of the activity description 704 used for informational purposes. In some embodiments it follows to enter the activity to be performed 706, which may be a positive behavior, an exercise, or a negative behavior (e.g. fighting). What follows is the entry of the number of points earned (or deducted, e.g. for a bad behavior) for the activity 708. Finally, once the activity configuration is complete, the activity is added 710 to the system.

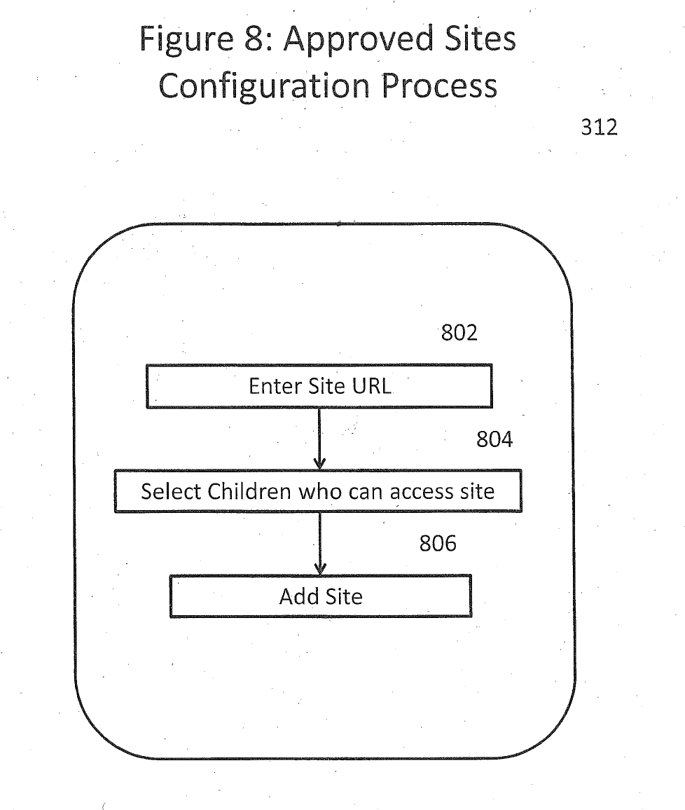

FIG. 8 is a flow chart describing the process of adding approved sites 312 initially described in FIG. 3. In certain embodiments the steps in FIG. 8 could be performed in an alternate order, and in some embodiments not all steps are required. The list of steps included in FIG. 8 is representative of a variety of common situations without being limiting to a specific combination or order. In certain embodiments the first step of configuring an approved site is entering the site URL 802 or URLs which specifies the approved site(s). The next step is to select the children who are allowed to access the site 804, before finally adding the site 806 to the system. One of ordinary skill in the art could see how the access approval process could be reversed so as to list the sites denied by user within the system. In common parlance, the first method is called a “whitelist” while the latter method is a “blacklist”. Similarly the site blacklist or whitelist could be device specific as well as user specific. Finally, it is also envisioned that the configuration of a site could include various other restrictions or controls on access, such as time or day or other measures.

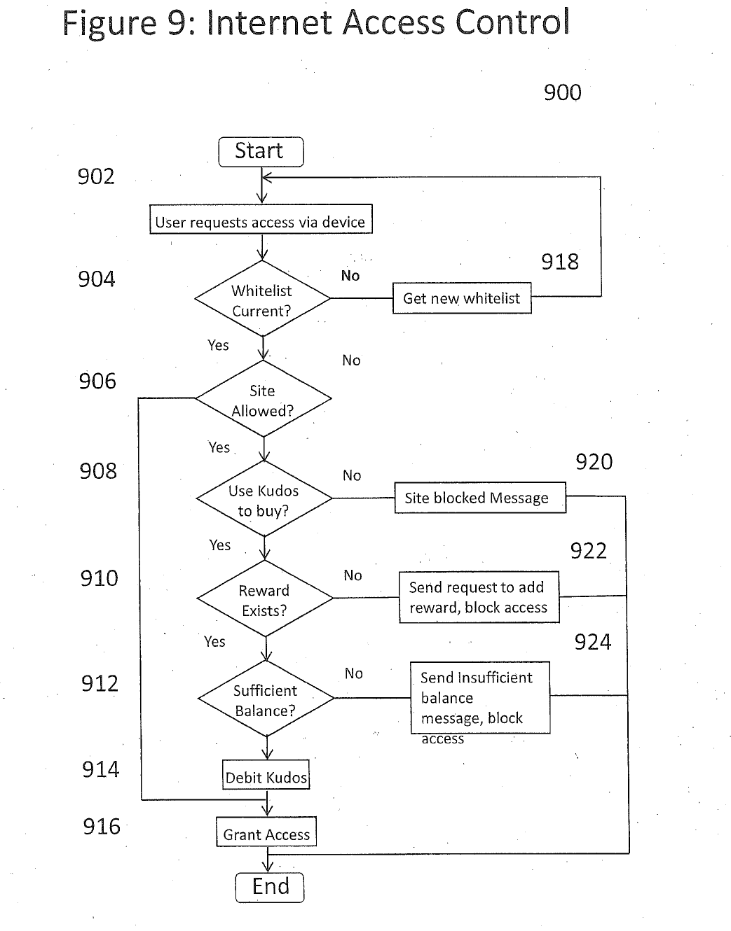

FIG. 9 is a flow chart describing the process of requesting internet access 900. In certain embodiments the steps in FIG. 9 could be performed in an alternate order, and in some embodiments not all steps are required. The list of steps included in FIG. 9 is representative of a variety of common situations without being limiting to a specific combination or order. In certain embodiments the first step is recognizing a user or assigned device requesting internet access 902. In some embodiments the next step is to check to see if the whitelist (or blacklist) is current 904, and if not is updated from the server 918. If the requested site is allowed 906 in all cases, then access is granted 916, otherwise a determination is made whether the site is one which requires points to buy access, and the user is prompted with that decision 908. If the user has sufficient points in their reserve to purchase access 912 and the site is approved as one which is available as a reward for redemption 910, then the points are deducted 914 and access is granted 916. However if the site is not allowed even via purchase with points, a site blocked message is presented to the user 920. Similarly, if the site is not allowed as part of a reward, a request to add the site is sent to the administrator and a blocked access message is presented 922. Finally, if everything else is fine but the user does not have enough points to redeem for access, an insufficient balance message is sent and the site is blocked 924.

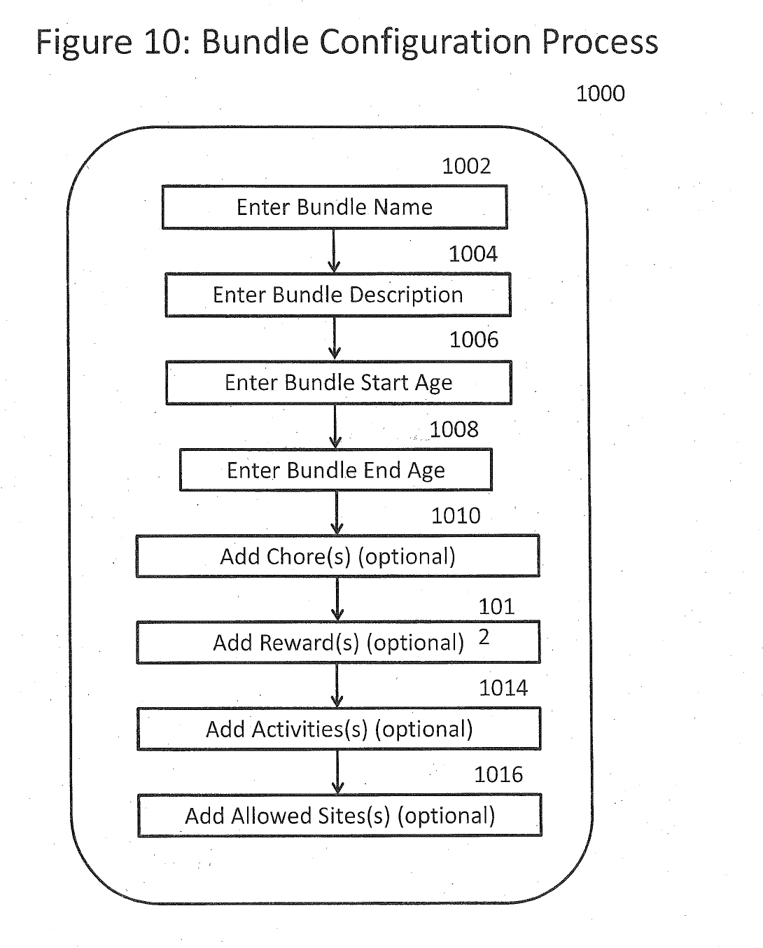

FIG. 10 s a flow chart describing the process of configuring a bundle 1000. Bundles are used to create groups of chores, rewards, activities, allowed sites, etc. where a bundle can be used in the place of an individual item during the configuration and access/usage processes. In certain embodiments the various steps in FIG. 10 could be performed in an alternate order and in some embodiments not all steps are required. As with prior figures, the list of steps is presented for descriptive purposes and the steps may be presented in any number of different combinations depending upon the embodiment. In certain embodiments the first step for creating a bundle is to enter the bundle name 1002 for identification purposes. Next, in some embodiments is the entry for a bundle description 1004 which is used for description. In some embodiments a start age 1006 and end age 1008 are added as part of the bundle to determine when the bundle is applicable. Then, depending on the type of bundle being created, one or more chores are added 1010, one or more rewards are added 1012, one or more activities are added 1014, or one or more sites are added 1016.

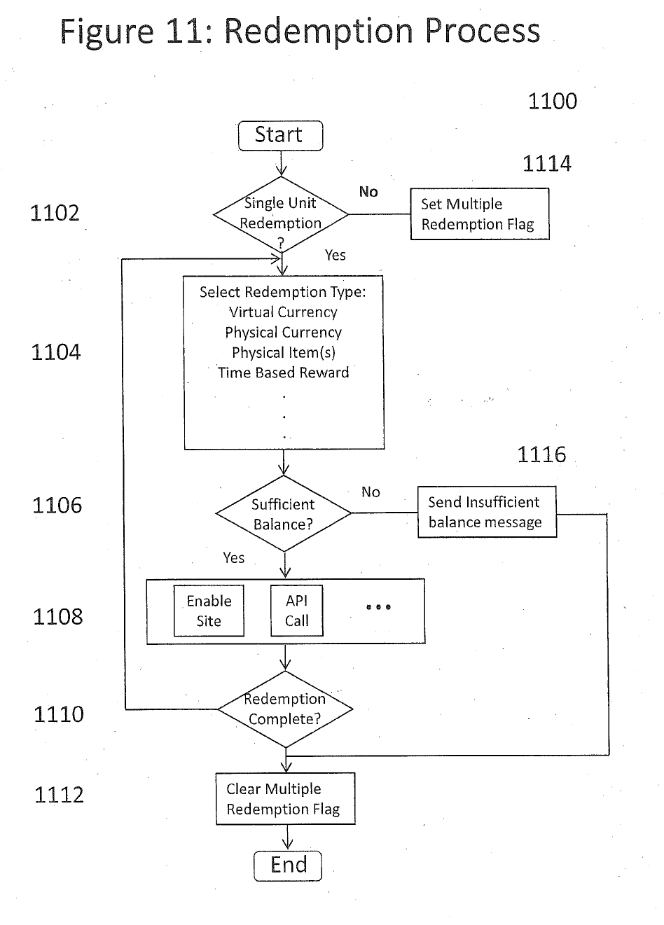

FIG. 11 is a flow chart describing the process of redeeming a reward 1100. Rewards are earned over time as virtual currency, points, or kudos, and can be redeemed for a variety of uses. In certain embodiments the various steps in FIG. 11 can be performed in an alternate order and in some embodiments not all steps are required. As with prior figures, the list of steps is presented for descriptive purposes and the steps may be presented in any number of different combinations depending upon the embodiment. In certain embodiments the first step for redeeming accrued points is to determine if the redemption is for a single unit 1102. If not, a multiple redemption flag is set 1114 which is used later when determining if the redemption process is complete 1110. When redeeming, a choice of what type of redemption is made from a variety of redemption types 1104, such as physical currency, physical items, time based rewards, etc. When a redemption is selected, the available balance is checked 1106. If there is not sufficient balance available, then an insufficient balance message is given 1116 before escaping from the redemption loop. If sufficient balance exists for the chosen redemption, then the appropriate redemption process occurs 1108, including such options as enabling an Internet set, allowing a TV program to play, making an API call to an external device or system to unlock capabilities or exchange money, or any number of other relevant activities. If the redemption process is complete 1110 as determined by user choice and whether multiple redemptions are chosen 1114, then the redemption loop occurs again starting with a selection of redemption type 1104. Otherwise, when all redemptions are complete the multiple redemption flag is cleared 1112 if it was previously set.

### Example 1—Chores

Matt and Amy have a 13 year old daughter, Ann Ann is supposed to clean her room once per week, clear her dishes after every meal, help with weekly cleaning duties around the house, and do the family laundry on Sundays and Thursdays. However, Matt and Amy have noticed that Ann often does not complete certain chores regularly and others are done late. They have reached a point of conflict where Matt and Amy are seen as adversaries. They feel that there is likely something better they can do to keep Ann on task that is less confrontational than what they are doing. Further, they suspect that there is something amiss with their simple set of tasks and they would like to increase Ann's responsibilities when she is motivated.

Matt happens to find out about Kudoso, an interne service and device which helps families manage their chores and outcomes. Matt and Amy purchase Kudoso and configure it for Ann's chores. First, they enter each of Ann's required tasks and the days or times that they want Ann to complete each one. They mark this group of chores as the required set for Ann to receive any Kudoso points, but when complete they are worth a total of 20 points. Next, they enter a number of other tasks that Ann could do if she would like the extra work, and assign a point value for each task. They add the tasks of feeding their family dog Duke twice per day (at 0.5 points per day), cleaning the cat litter box (2 points per cleaning), making a special meal or dessert for the family (2 points per meal), and running the dishwasher and putting the dishes away (1 point). Since they have been having trouble with Ann's chore completions, they also specify that if the base chores are incomplete, then there will be a deduction of 10 earned Kudoso points.

When Matt and Amy enable the Kudoso system, Ann is interested and the first week she does all her chores and earns her 20 base points plus an additional 6 points for other tasks, as recorded daily by Matt or Amy. Of these 26 points Ann redeems 12 and leaves 14 in her Kudoso bank. However, the second week using Kudoso, Ann does not do so well. She fails to clean her room and does not get around to doing laundry on Thursday and instead does it on Friday. She did, however, feed Duke two days. At the end of the week, since Ann did not complete, her required base tasks, her Kudoso balance for the week is −10 for the incomplete tasks plus 1 for feeding Duke for a total of −9 points for the week. When the 9 points are deducted from her balance of 16 from the previous week, she is left with 7 points in her balance. She redeems all of these and feels bad that she does not get as much internet recreation time as she did the previous week when she redeemed 12 points. The third week Ann is back on track and she completes all her base tasks and ends the week with a total of 25 points.

The following week Ann is petulant and decides to stop doing her chores at all. Matt and Amy have already configured the system for this scenario and have enabled the “negative punishment” feature which modifies the access list to enforce a younger age access policy. Ann realizes that her childish behavior has caused the system to treat her as younger than she feels appropriate, and the fifth week she is back on track and performs additional chores which re-enable her age-appropriate access.

### Example 2—Chores and Behaviors

Matt and Amy finally were able to identify a great solution for Ann to do her chores. The family was now working together well with the Kudoso system. They decide to add a few modifications to their configuration. As an attempt to get Ann to focus on her school grades, they add a homework requirement to Ann's chore list. Ann's school is fairly technologically savvy and has a web site where the teachers mark homework completion. Matt and Amy connect their Kudoso system to Ann's account on the school site for homework tracking and add this to her required chore list; if Ann does not turn in her homework she does not get credit for completing her chores and she gets Kudoso points deducted.

In addition, Matt's employer recently enacted a new health policy related to exercise. Matt and Amy decide to use the opportunity to have the whole family exercise more. They purchase some electronic pedometers for all three of them and set an exercise goal of walking 1 mile per day. If they do the target amount of walking they are allowed access to Facebook for the week. If they don't make their target their internet is disabled between 6pm and 9pm. Kudoso allowed the “negative reinforcement” of removing a filter on internet activity (Facebook) on successful completion of a task, and also the “negative punishment” of restricting access to the internet. Matt and Amy appreciate the functionality within Kudoso to operate on more than simple addition or subtraction of points and to instead offer a wider set of behavioral tools that work for the variety of situations the family experiences.

### Example 3—Kudos Redemption

Ann has been using Kudoso for about 6 months and has a net Kudoso balance of 77 points. She has become savvy about her use of the Kudoso points. She recognizes that she is allowed to convert her points for cash at $1 per point, and all she needs to do when she needs that money is to talk to either Matt or Amy and she will receive the pocket money and her point balance will be deducted, or she can opt to transfer the points as money directly into her bank savings account online. In addition, she has a favorite game she likes to play on her phone with her friends. She uses a point for each 30 minutes of play on her phone game. However, sometimes she feels tired and just wants to watch some television. Since television also comes at a cost of points, she usually opts to watch the natural history shows her parents have set to cost only 1 point for each hour instead of the sitcom “Suzy” that all her friends watch because that costs 1 point for every 30 minutes. Ann likes that she gets the option of using her earned points in different ways, and is learning that each of her activities come at some cost, and is learning not just money management but time management as well.

Kudoso has recently implemented a wish-list feature on their site. Ann starts using this to track the items, from clothes to movies to music to toys, which she would like. Matt and Amy are able to review the wish list and allow the items in the wish list to also be redeemed for various Kudoso points. They recognize that they are willing to exchange 1 point for $1, and for those items on the wish list that are acceptable to them but not desired, they allow the 1:1 conversion. However, some of the items on Ann's list are things that Matt and Amy would like Ann to have, so they offer various conversion factors on each item. Some items, like a particularly styled alarm clock, they set as 1 point =$10 because the know that Ann would use this to be more on time in the mornings. Some items, like a documentary movie rental, they set at 1 point =$2. Some of the clothes that Ann lists they allow for 1 point =$1.50, while others they are less fond of they allow for 1 point =$0.50. Finally, Matt and Amy have specified that any points converted to Ann's long term savings plan are granted at $1.50 instead of $1 for her pocket money.

Now Ann has the ability to not only use Kudoso points for allocating her time amongst entertainment choices and money, but also a variety of things that she would like to buy. She recognizes that with the use of the various conversion factors on her Kudoso points she can choose her own items for redemption and also recognizes that her parents have some influence in specifying which things they approve of more than others while leaving the final choice up to Ann. This combination makes Ann feel more responsible for her behaviors and it allows Matt and Amy to be comfortable with Ann's choices.

### Example 4—Education

Matt and Amy would like to get Ann some additional tutoring in math to bring up her grades in school. They are able to hire a tutor, Joe, who is able to get them on track with Ann's studies by identifying a set of internet sites to help practice her weaknesses. The sites include Khan Academy (e.g. URL https://www.khanacademy.org/commoncore#grade-7) IXL (e.g. URL http://www.ixl.com/math/grade-7) and AAAMath (e.g. URL http://www.aaamath.com/grade7.htm). Joe recommends Ann spend 30 minutes per day on the Khan Academy site, and to supplement that training with specific items from the other two sites. Matt and Amy decide to configure the Kudoso system to have the Khan Academy internet time become one of Ann's daily chores and to identify the series of other specific items to be bonus tasks worth 0.5 points each. The Kudoso system easily allows Matt and Amy to include specific internet sites as accessible not only without redeeming points, but also as conditions to earn points. This allows them to seamlessly include internet activities as part of a chore set. In addition, they configure the coach capabilities to allow Joe the opportunity to not just interact as the Khan academy coach, but also to allow Joe to help adjust the sites and suggestions on the Kudoso system.

After Matt and Amy become knowledgeable about the Khan Academy, they discover the badging system available on that site consisting of “proficient”, “suggested”, and “review”. They are able to further incorporate these badges with Joe's list of required skills for Ann to practice, and they modify the Kudoso system to give additional 1 point rewards to Ann for each “proficient” badge she earns in her studies.

This combination of required study and specific targeted extra work and external system determined rewards allows Ann to quickly develop her math skills by recognizing the value they provide. In addition, her increased math awareness helps her understand the nature of the Kudoso scoring system and she is further encouraged to perform her chores, exercises, and studies more effectively.

### Example 5—Configuration for Multiple Parties

Matt and Amy's friends Travis and Amber Smith have seen how effective Kudoso has been for Ann They decide to try it with their two children Dan and Andrew. Dan is 12 years old and Andrew is 7. In the Smith household, each person has multiple internet devices they each use regularly, as well as their shared media center. Travis has a laptop and iPad, Amber has a laptop and a phone, Dan has an iPod Touch music and media player and a phone, while Andrew has a Kindle electronic book reader and media player and an iPod Touch.

Amber is able to easily install the Kudoso system even though she has no experience with computer networking. As soon as each device in the house connects to the internet she is able to see it as attempting access and assign it to one of the individuals in the family. She identifies each device and its owner, as well as the associated chores for each person. She includes herself and Travis for a set of goals that they would like to accomplish, such as exercise and trying new recipes for family meals.

After the family uses Kudoso for a while both Travis and Amber are quite pleased that the redemption of points is per individual and per device. This makes sure that both Dan and Andrew are not forced to use a device that is tied to the points, but also that there is no loop-hole where they can access content with a device that is outside the Kudoso access permission system. They are also pleased that they can represent different points for the same activities performed by each child. Since Dan is older and more capable, he is assigned fewer points for tasks that both he and Andrew must complete. Also, Dan and Andrew's different personalities are manifest in their sometimes opposite behaviors. Where Dan is outgoing, Andrew is shy. Travis and Amber are able to implement negative repercussions for Dan dominating interactions, but give positive repercussions for Andrew doing the same.

### Example 6—Bundles

When Amber configures her new Kudoso system she discovers that a number of default bundles exist to aid her configuration. She finds the set of chore bundles that include a list of chores appropriate for a 4 year old, a 5 year old, and so on through 18 years old. She reviews the bundle for her 7 year old Andrew and discovers that it closely matches the chore set that Andrew was already doing, but has an additional chore of feeding pets that she had not thought to have Andrew perform. She selects that default chore set for Andrew. When she reviews the system default chore set for Dan, her 12 year old, she discovers it includes loading and emptying the dishwasher. Their house does not have a dishwasher so she selects the default 12 year old bundle but removes the dish washer chore. She then adds the additional chore of taking out the recycling that she has had Dan already doing for one of his chores but was not included in the default chore set.

During the configuration Amber discovers that there are additional default system bundles she can choose from for individuals to earn points, including learning bundles and activity bundles. Some of the bundles are also age-related while others are independent of age recommendations. She reviews the first-grade learning bundle and decides to implement it for Andrew so he can improve his math and reading abilities by studying from a set of internet content sites, but she decides that Dan is already a straight-A student self-motivated to study so she does not include any learning bundles for Dan. Amber is interested in the language learning bundle and chooses the Spanish learning bundle for her and Travis so they can prepare for an upcoming trip to Mexico. Requiring the bundle for earning internet access for each of the parents gives them the reminder to do this task they keep putting off.

Amber also notices the activity bundles. Included are various beginning, intermediate, and advanced exercise bundles which include walking, cycling, calisthenics, basketball, and a number of other options. She selects a bundle for her family which includes walking the dog and several weekend cycling outings.

During another phase of configuration, Amber discovers that in addition to chore bundles, there are redemption bundles. She reviews these and discovers in a 7 year old age related redemption bundle that there are certain internet sites disallowed from access, like Facebook, and also some media content restrictions, like only G movies, and YouTube™ Green ratings. When she reviews the 12 year old age related redemption bundle she notices that Facebook, which restricts users to 13 years old or older, is also restricted. However the allowed movie rating is increased to include PG and YouTube™ content ratings now allow Yellow ratings for language and nudity, but still enforce Green on sexual situations and violence. Amber decides that these bundles apply well for her family and she enables them.

Later Amber discusses the bundles with her friend Amy and learns that Amy had created a custom bundle for her 13 year old daughter Ann Amy sends the bundle definition to Amber so that she can review it and consider using it for Dan. Upon further research, Amber also notices that there are additional 3^{rd} party bundles available on the Kudoso web site for unique categories, such as Christian bundles, homeschool bundles, athlete training bundles, farm family chore bundles, and city family chore bundles. Some of the bundles were available for free while others came at some cost. Each bundle offered a different set of chores, exercises, study lists, and redemption amounts and restrictions. Amber notes the availability of these various bundles for future consideration.

### Example 7—Clubs/Schools

Sometown Middle School has recently begun using a Kudoso internet access point to help with the variety of devices in use in the school. They have configured the Kudoso system for each student based upon age and grade level. They have enabled each teacher to structure homework assignments for the various students as the required work to gain Kudoso points that they can use to redeem for internet access (within the school and age/grade policies) as well as for special library privileges and extra in-school free periods. Each student can now, on their own phone or tablet device or on the school's computer system with proper credentials, choose how to use their accumulated points. Some choose to work hard for free time to play games, while others fall behind and get their access restricted and additional assignments.

The Kudoso system has worked so well for the school that several local clubs have also begun using it to help incentivize their members to help out with extra club duties. Some social clubs have used it to encourage members to do various meeting-room cleaning and club administrative tasks, while other clubs use it to encourage volunteer tasks.

### Example 8—Badges & Gamification

When Matt and Amy begin using the Kudoso system they discover that each activity can have a set of badges to encourage completion. Individuals can earn badges by completing various tasks, for instance the “Consistent Week” badge for completing all chores for the week, the “Consistent Month” badge for completing all chores for that month, and so on. There are also other badges for the amount of points saved, for the amount and types of redemption, and so on. Some basic badges are automatically enabled, others are enabled based upon the bundle, and others are optional. For example, Matt notices that the “Consistent” badges are used by default. The “athlete” badges are enabled when using one of the exercise packages, and the “brainiac” badges are enabled with the learning packages. Amy discovers that she and Matt can create their own badges for the chore sets they have made for their daughter, Ann, and create a “Hard Worker” set of badges for completing extra tasks beyond her required chores. They also notice that some badges are simply there for recognition, while others come with additional access grants and others come with free Kudoso points. They enable a bonus 25 Kudoso points for the “Consistent Month” and also configure their 3^{rd} level “Hard Worker” badge to allow more access via the next higher age bundle, while the remainder of the badges they choose to use are simply for encouragement and recognition.

The examples provided above are not intended to be an exhaustive explanation of each possible operation of the systems and methods described herein, and the various embodiments are not limited to any example described above.

Although an overview of the inventive subject matter has been described with reference to specific example embodiments, various modifications and changes may be made to these embodiments without departing from the broader spirit and scope of inventive subject matter. Such embodiments of the inventive subject matter may be referred to herein, individually or collectively, by the term “invention” merely for convenience and without intending to voluntarily limit the scope of this application to any single invention or inventive concept if more than one is, in fact, disclosed.

As is evident from the foregoing description, certain aspects of the inventive subject matter are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the spirit and scope of the inventive subject matter. Therefore, it is manifestly intended that this inventive subject matter be limited only by the following claims and equivalents thereof.

The Abstract is provided to comply with 37 C.F.R. §1.72(b) to allow the reader to quickly ascertain the nature and gist of the technical disclosure. The Abstract is submitted with the understanding that it will not be used to limit the scope of the claims.

1. A computer implemented method of encouraging behavior of a participant by providing a virtual behavior recognition economy, said method comprising the steps of:
storing an account of said participant in a memory,
receiving instructions at a processor which identifies said participant and tasks to be performed by said participant,
receiving a request to create points to be redeemed as virtual currency,
storing in a data memory associated with said processor a number of points and tasks having attributes corresponding to said virtual currency,
scoring by way of allocating points for the performance of said tasks over a preselected time period,
increasing the number of points upon the occurrence of a satisfactory performance score,
decreasing the number of points upon an unsatisfactory performance score,
storing at least one activity which said participant finds pleasurable,
assigning a preselected point value to said at least one activity, and
receiving a request to redeem points stored in said data memory in consideration for the virtual purchase of said one pleasurable activity.

2. The method as in claim 1 wherein said one pleasurable activity is access to the internet.

3. The method as in claim 1 including the step of restricting the points that may be redeemed as a result of the behavior of the participant.

4. The method as in claim 1 including the step of expanding the points that may be redeemed as a result of the behavior of the participant.

5. The method as in claim 2 including the step controlling internet access by a local computing device.

6. The method of claim 2 including the step of controlling restrictions on a local computing device.

7. The method of claim 2 including the step controlling the routing of internet access to a local computing device to thereby permit said local computing device to do one of connect to the internet, preclude connection to internet, apply restriction on internet access, and apply condition for internet access.

8. The method of claim 7 including the step of granting said local computing device unrestricted access to internet.

9. The method of claim 7 including the step of granting said local computing device restricted access.

10. The method of claim 9 wherein restrictions may be based on one of specific time of day, amount of usage, and accessible sites.

11. A computer implemented system for encouraging behavior of a participant by providing a virtual behavior recognition economy, said system comprising:
means for storing an account of said participant in a memory;
means for receiving instructions at a processor which identifies said participant and tasks to be performed by said participant;
means for receiving a request to create points to be redeemed as virtual currency;
data memory associated with said processor in which a number of points and tasks having attributes corresponding to said virtual currency may be stored;
means for scoring by way of allocating points for the performance of said task over a preselected time period;
means for increasing the number of points upon the occurrence of a satisfactory performance score;
means for decreasing the number of points upon an unsatisfactory performance score;
means for storing at least one activity which said participant finds pleasurable;
means for assigning a preselected point value to said at least one activity; and
means for receiving a request to redeem points stored in said data memory in consideration for the virtual purchase of said one pleasurable activity.

12. The system as in claim 11, wherein said one pleasurable activity includes a means to grant access to the internet.

13. The system as in claim 11 including means for restricting the points that may be redeemed as a result of the behavior of the participant.

14. The system as in claim 11 including means for expanding the points that may be redeemed as a result of the behavior of the participant.

15. The system as in claim 12 wherein said pleasurable activity includes access to the internet and including means for controlling internet access by local computing device.

16. The system as in claim 12 wherein said pleasurable activity includes access to the internet and including means for controlling restrictions on a local computing device.

17. The system as in claim 12 wherein said pleasurable activity includes access to the internet and including means for controlling and routing of internet access to a local computing device to thereby permit said local computing device to do one of connect to the internet, preclude connection to the internet, apply restrictions on internet access, and apply conditions for internet access.

18. The system as in claim 17 including means for granting said local computing device unrestricted access to the internet.

19. The system as in claim 17 including the step of granting said local computing device restricted access.

20. The system in claim 19 wherein restrictions may be based on one of the specific time of day, the amount of usage, and accessible sites.

21. A computer implemented gamification method wherein the task completion is encouraged by a virtual economy, said method comprising the steps of:
storing an account of said participant in a memory,
receiving instructions at a processor which identifies said participant and said bundle of tasks to be performed by said participant,
receiving a request to create points to be redeemed as virtual currency,
storing in a data memory associated with said processor a number of points and said bundle of tasks having attributes corresponding to said virtual currency,
scoring by way of allocating points for the performance of said bundle of tasks over a preselected time period,
increasing the number of points upon the occurrence of a satisfactory performance score,
decreasing the number of points upon an unsatisfactory performance score,
storing at least one activity which said participant finds pleasurable,
assigning a preselected point value to said at least one activity, and
receiving a request to redeem points stored in said data memory in consideration for the virtual purchase of said one pleasurable activity.

22. The method as in claim 21 wherein said one pleasurable activity is access to the internet.

23. The method as in claim 21 including the step of restricting the points that may be redeemed as a result of said bundle of tasks being satisfactorily completed.

24. The method as in claim 21 including the step of expanding the points that may be redeemed as a result said bundle of tasks being completed by the participant.

25. The method as in claim 22 including the step controlling internet access by a local computing device.

26. The method of claim 22 including the step of controlling restrictions on a local computing device.

27. The method of claim 22 including the step controlling the routing of internet access to a local computing device to thereby permit said local computing device to do one of connect to the internet, preclude connection to internet, apply restriction on internet access, and apply condition for internet access.

28. The method of claim 27 including the step of granting said local computing device unrestricted access to internet.

29. The method of claim 27 including the step of granting said local computing device restricted access.

30. The method of claim 29 wherein restrictions may be based on one of specific time of day, amount of usage, and accessible sites.

31. The method as in claim 1 wherein the pleasurable activity includes a plurality of wish list choices, and including the step of permitting said participant to redeem said points for one or more of said wish list choices.

32. The method as in claim 31 including the step of assigning a conversion rate to said wish list choices.

33. The method as in claim 32 including the step of changing the conversion reate depending on a preselected value assigned to one or more of said choices.

34. The system as in claim 11 wherein said pleasurable activity includes a plurality of wish list choices, and means for permitting said participant to redeem said point for one or more of said wish list choices.

35. The system as in claim 34 including means for assigning a point conversion rate to said wish list choice.

36. The system as in claim 35 including means for changing the conversion rate depending on a preselected value assigned to said one or more choices.
